(19) United States
(12) Patent Application Publication
(10) Pub. No.: US 2015/0363154 A1
(43) Pub. Date: Dec. 17, 2015

(54) CONTROL FOR MULTI-MONITOR DISPLAY

(71) Applicant: HEWLETT-PACKARD DEVELOPMENT COMPANY, L.P., Houston, TX (US)

(72) Inventors: John Frederick, Spring, TX (US); David M. Nypaver, Houston, TX (US)

(21) Appl. No.: 14/763,440

(22) PCT Filed: Jan. 30, 2013
(86) PCT No.: PCT/US13/23785

§ 371 Date: Jul. 24, 2015

(51) Int. Cl. G06F 3/14

(52) U.S. Cl. CPC G06F 3/1423

(57) ABSTRACT

An example system includes a multi-monitor display (10) having two or more display monitors (12-28); a receiver (34) for receiving control signals transmitted by a controller (36); and a signal conduit (38) for communication between the receiver (34) and the two or more display monitors (12-28). The signal conduit (38) may be a wired connection from the receiver (34) to the two or more display monitors (12-28).

### BACKGROUND

Advances in technology have improved many aspects of display monitor quality and have facilitated the display of increasingly clear and high-resolution images, even at large screen sizes. In addition, the light weight of modern display monitors has made them easier to mount and increased their portability. These characteristics make them popular for applications such as presentation displays, message boards, advertising platforms and other uses, particularly those where large, clear images are desired. For example, displays in public spaces such as exhibition halls, as well as other gatherings where video or other multimedia content is displayed, often call for a large, clear screen or display monitor.

Since individual display monitor sizes may be limited by factors such as available glass-panel size, as well as manufacturability and portability concerns, aggregating and grouping a number of individual display monitors into a unitary multi-monitor display wall affords even larger display screens than the largest-available individual display monitors. In addition to large-scale installations such as those at stadiums, exhibition halls and other public gathering places, multi-monitor systems can provide attractive and eye-catching displays for smaller-size applications such as home theaters and individual displays such as those for business presentations or individual trade show booths. The advent of lightweight, modern display monitors facilitates ease of portability and the quick assembly of numerous smaller monitors into an integrated display for such purposes.

### BRIEF DESCRIPTION OF THE DRAWINGS

For a more complete understanding of examples described herein, reference is now made to the following descriptions taken in connection with the accompanying drawings in which:

FIG. 1A is a perspective view of the front side of a multi-monitor system according to an example;

FIG. 1B is a detail view of an area of FIG. 1A, illustrating the relationship between adjoining display monitor bezels in an example;

FIG. 2 is a perspective view of the back side of a multi-monitor system according to an example;

FIG. 3 is a screenshot of an on-screen display menu according to an example;

FIG. 4 is a flowchart illustrating a process according to an example.

### DETAILED DESCRIPTION OF THE DRAWINGS

Multi-display monitor systems may also provide a diversity of views and display modes available with single-screen monitors. Thus, in addition to the benefits of larger display size, aggregations and groups of display monitors arranged edge-to-edge may facilitate enhanced display modes such as “span,” where a single input or image is spread across several closely-neighboring monitors; “clone” or “mirror,” where the same input or image is displayed on each display monitor in a closely-neighboring group; and “multi-image,” where different and unique inputs or images are displayed on each display monitor, or on “subgroups” of several display monitors within a larger group. Furthermore, as with televisions and other monitors, display settings and inputs for multiple-screen monitor systems may be controlled and managed through remote control devices. For example, adjustment of color, hue and other settings may be facilitated for individual monitors through a remote control transmitter in order to provide uniform display within a multi-monitor display system. In such systems, it is typical for all display monitors in a multi-monitor display system to simultaneously respond to remote signals, (e.g. remote wireless signals such as infrared (IR) signals) transmitted from a controller.

Thus, remote control transmitters may be used to control the inputs and settings of one or more monitors within a multi-display monitor system. However, arranging multiple display monitors into groups and display systems may present certain technical and logistical challenges. For example, the “bezel,” or non-display frame surrounding a screen display portion of a display monitor may detract from the unified appearance or continuity of an image displayed on an arrangement of monitors configured edge-to-edge. The wider the bezel (as measured from the edge of a display viewing area to the outer edge of the bezel/frame), the more negatively an image displayed on such a multiple-monitor display is affected.

Although the advent of “thin bezel” display monitors mitigates this concern to some extent, another challenge is raised by thin bezel display monitors: implementation of remote control, especially via infrared signals as are commonly used for transmitting control signals to televisions and other display monitor devices. As with single display monitors or televisions, the monitor inputs and a variety of settings of multi-display groups may be selected and controlled by control signals transmitted from a remote control unit or transmitter device, such as an infrared (“IR”) transmitter. A wide bezel on individual display monitors allows for placement or configuration of a remote control signal receiver on the bezel, where it may easily receive remote control signals from a transmitter device that is aimed at the display. However, thin-bezel display monitors, by the nature of their narrow-width bezels, do not allow for placement of a receiver on their bezels. In fact, very little of a thin-bezel display monitor other than the glass display panel itself is visible to a viewer, thus leaving little or no space for mounting an IR receiver. As a result, the remote signal receivers of thin-bezel display monitors are commonly mounted on the back of such display monitors.

Display monitors with back-mounted remote control signal receivers may easily receive remote control signals if neighboring objects are not positioned in close proximity to the outer edges of the display monitor bezels. However, the more closely that neighboring objects are positioned to the edge of a display monitor bezel, the more difficult it can be for the respective remote control signal receiver to receive transmitted control signals. For example, in a multi-monitor display wall, display monitors may be surrounded by other monitors on several or all sides. The close configuration of surrounding display monitors may make it difficult or impossible for control signals to be received by display monitors that are surrounded by others, particularly where the receivers are mounted on the backs of respective display monitors. Also, if a multi-display monitor system is mounted at some height above a remote control transmitter, or within a cabinet or other enclosure that adjoins the display monitor system's outer edges, the reception of control signals may be very poor or completely blocked.

Various examples described herein may thus be directed to controlling display monitors within, for example, a display group of two or more monitors, as well as facilitating overall control of the larger display, through a receiving unit that may receive transmitted control signals and may be capable of distributing control signals to one or more individual monitors or a subgroup of monitors of the display group. As a result, it is easy to quickly adjust a single display monitor, a subgroup of monitors or all display monitors in a group. Where display monitors that have control signal receivers on their backs (e.g., thin-bezel displays), the control signal reception may be greatly improved and various mounting and configuration options for a grouped display may be facilitated.

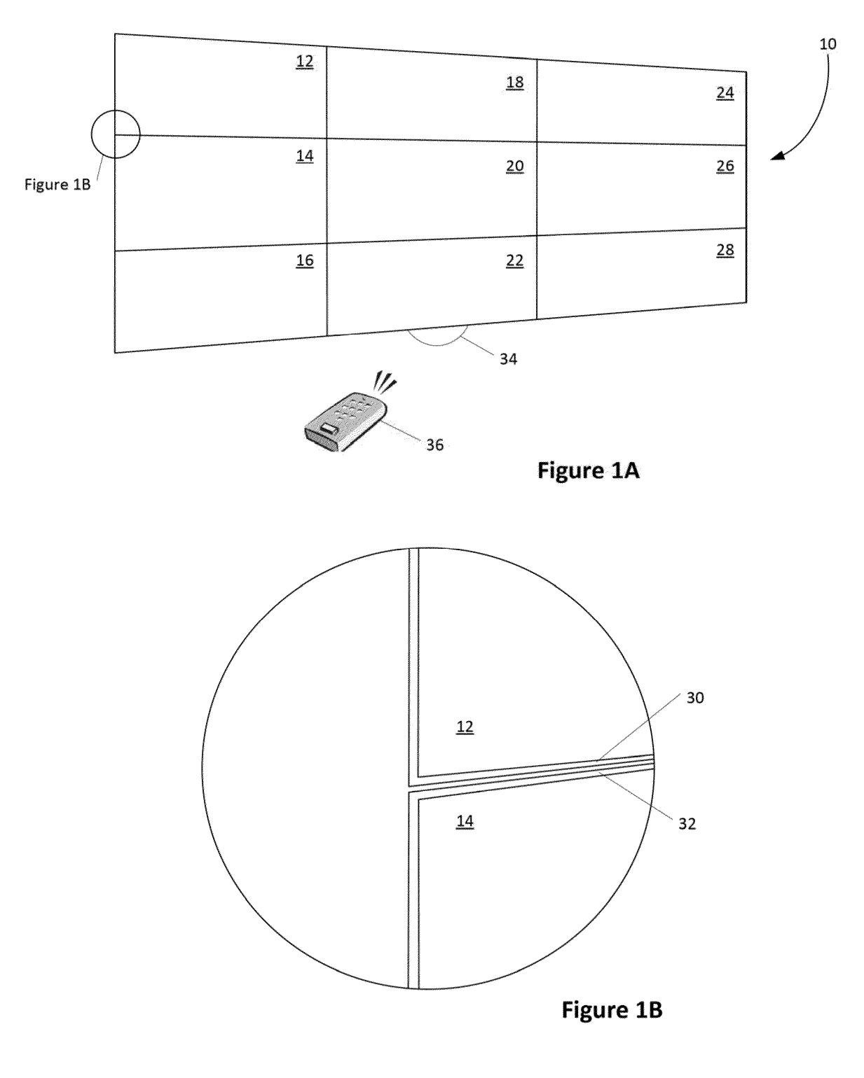

In an example as illustrated in FIG. 1A, a multi-monitor display includes a group of monitors 10 includes display monitors 12, 14, 16, 18, 20, 22, 24, 26, 28 arranged in an edge-to-edge configuration. More specifically, FIG. 1B provides a detail view of the circled area in FIG. 1A, illustrating the bezel edge 30 of display monitor 12, in a closely-spaced or abutting relationship with bezel edge 32 of display monitor 14. In the example of FIGS. 1A and 1B, the display monitors 12, 14 described and illustrated in connection with this example include so-called “thin” bezels 30, 32. In other examples, display monitors may be made with bezels of varying width. The concepts described herein are not limited to applications with display monitors having bezels of any particular size or even shape. Various examples may utilize, incorporate, or operate in connection with display monitors having bezels of any width or shape. Moreover, various examples described herein may utilize, incorporate or operate in connection with various grouped configurations of display monitors, whether any or all of the display monitors in a particular group are in abutting contact relationships with each other, or spaced any distance apart from one another.

Referring again to FIG. 1, in an example, display monitors 12, 14, 16, 18, 20, 22, 24, 26, 28 may be configured to display selectable input in various modes. Selectable input may include any content, signal, broadcast, or other information (e.g., multimedia content) that may be selected from available input channels and provided to one or more display monitors for display thereupon. Selectable inputs may be selected for display through various methods, such as by using a remote control to transmit signals that cause a monitor or group of monitors to display a selected input (e.g., selecting “Input 1,” “TV/DVR,” “A/V 1,” or any other input that may be connected to a monitor or group of monitors and available for display). In various examples, selectable input may be displayed on the group of monitors 10 in a “span” mode, whereby a single selectable input is spanned across multiple monitors (e.g., all monitors 12, 14, 16, 18, 20, 22, 24, 26, 28) in the group of monitors 10 in a unitary display of the input. In various examples, mirror mode include mirroring, or displaying the same input on each display monitor in the group of monitors 10, individually, or on subgroups of display monitors. In various examples, multi-image mode may include the display of a unique and different selectable input on each monitor, or the display of different selectable inputs on subgroups of monitors within group of monitors 10. In an example of multi-image display mode, display monitors 12, 14, 18 and 20 may together form a subgroup and display a particular input, while display monitors 16, 22, 24, 26 and 28 may display a selectable input that is different from the input displayed on the subgroup formed by display monitors 12, 14, 18 and 20. In other examples of multi-image display mode, display monitor 20 may display a different and unique input than a subgroup of the remaining display monitors; or, a subgroup of display monitors 12, 14, 16 may display one input, while another subgroup of display monitors (e.g., formed by display monitors 18, 20, 22) displays a second, different input; and a third subgroup of display monitors (e.g., formed by display monitors 24, 26, 28) displays a third different input. In multi-image mode, any combination and number of subgroups and individual monitors may thus be specified to display inputs that are different from those displayed on other monitors and subgroups. In various examples, individual monitors and subgroups may not be limited to displaying different selectable inputs, but may be capable of displaying the same selectable input as other individual monitors or subgroups; for example, any combination of identical or different inputs may be displayed on various individual display monitors and subgroups within a group. In various examples, and as will be discussed in greater detail below, a controller may be utilized to transmit signals regarding the selection and display of selectable inputs on constituent display monitors and subgroups of group 10, as well as the configuration of constituent monitors and subgroups, and display modes of group 10. The controller discussed in connection with this and other examples may be a remote control transmitter, such as a handheld remote control device that transmits infrared (“IR”) signals, for example.

In other examples, various wired and wireless technologies may be used to transmit signals. In one example, the remote control device may transmit signals in various wireless technologies including, but not limited to, IR, Bluetooth, radio frequency (RF), WiFi or any other appropriate wireless technology. In other examples, the signals may be transmitted through a control panel mounted on, for example, a wall. The wall may be proximate to or far from the multi-monitor display. In still other examples, the control panel may be part of one of the monitors.

In addition to the selection of display modes and configurations, display monitors within the group of monitors 10 may have variable settings. Settings refer to typical display adjustments available for display monitors and may include, but not limited to, parameters such as picture, color, size/position, brightness, contrast, hue, sharpness, etc. The settings of individual monitors or subgroups of monitors may require adjustment to facilitate uniform display of inputs across the group of monitors 10 or a subgroup thereof. For example, to facilitate uniform appearance of like colors across the group of monitors 10 (or a subgroup of display monitors), monitor 12 may be adjusted in order to display an input or a portion of an input with the same visible color, hue, sharpness, etc., as the neighboring display monitors 14, 18, 20. In various examples, and as discussed in greater detail below, a controller may be utilized to transmit signals regarding the specification and adjustment of settings for group 10, as well as individual constituent display monitors and subgroups of the group of monitors 10. Thus, the settings of any individual display monitor in the group of monitors 10 may be adjusted through control signals transmitted from a controller. Likewise, the settings of subgroups, or the group of monitors 10 as a whole, may be adjusted via control signals transmitted from a remote control device. As discussed above, in various examples, the controller may be a remote control transmitter, including a handheld remote control device that transmits infrared (“IR”) signals.

As discussed above, the group of monitors 10 may be made up of display monitors 12, 14, 16, 18, 20, 22, 24, 26, 28 with thin bezels, arranged edge-to-edge, as illustrated in the example of FIG. 1. As a result of having thin bezels, each display monitor may have a receiver disposed on its back for receiving control signals from a controller. Due to the close configuration of the display monitors 12, 14, 16, 18, 20, 22, 24, 26, 28, it may be difficult or impossible for the receiver on each monitor to receive control signals from a controller that are transmitted from the front of the group of monitors 10. Alternately it may be difficult for display monitors 12, 14, 16, 18, 20, 22, 24, 26, 28 of the group of monitors 10 to receive control signals when group 10 is disposed within an enclosure, such as a cabinet, or if mounted high above the location where a controller may be transmitting control signals. That is, when a receiver is not in a direct, or line-of-sight, relationship with a controller/transmitter, particularly one transmitting IR control signals, the reception of control signals may be very poor or non-existent.

Further, in cases of large groups of monitors, the IR transmission cone of a controller may not be sufficiently large to encompass the receivers of all of the monitors in the group. In such cases, in order to send a control signal to all of the monitors simultaneously, the controller may have to be positioned a great distance from the group of monitors. At such great distances, signal strength may be insufficient for the receivers of the monitors to receive the signal.

In such cases, it may be advantageous to configure a receiver (e.g., a remote external receiver) in a direct, or line-of-sight, orientation with respect to a controller, so as to more easily and directly receive control signals transmitted from the controller. Referring again to the example of FIG. 1, there is illustrated a receiver 34 disposed at the bottom edge of display monitor 22. In various examples, the receiver 34 is a wireless receiver capable of receiving wireless signals from a wireless transmitter, such as a wireless remote controller. In various examples, the receiver is capable of receiving wireless, infrared (IR) signals.

The location of the receiver 34 facilitates its ability to receive control signals from controller 36. As discussed above, the controller 36 may transmit, and the receiver 34 may receive, control signals via IR signals. Of course, the receiver 34 may be located in any position that is advantageous for receiving control signals from a controller 36. That is, in various examples, the receiver 34 may be disposed at any point along the periphery of the group of monitors 10 or any advantageous point on any edge of any of the display monitors of the group of monitors 10. In other examples, the receiver 34 may be disposed at a location that is remote from the group of monitors 10. For example, the group of monitors 10 may be installed in a cabinet or other type of enclosure, while the receiver 34 may be disposed at some location on or near the cabinet that facilitates effective reception of control signals transmitted from the controller 36. The receiver 34 is thus capable of being positioned at a location that provides for optimal reception of control signals and integration into the desired configuration of display monitors.

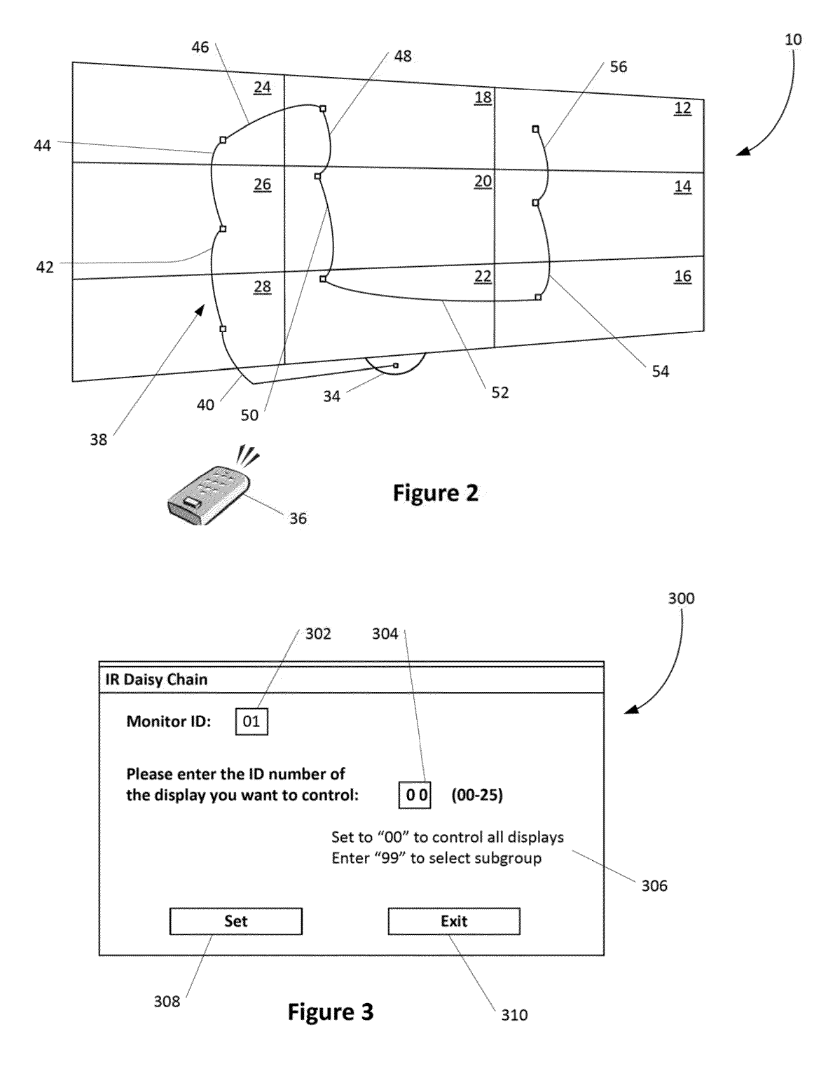

As discussed above, the receiver 34 may receive control signals from a controller. In various examples, the receiver 34 may be configured to distribute received control signals to any or all of the display monitors of the group of monitors 10. Referring now to FIG. 2, there is illustrated a rear view of the example group of monitors 10 illustrated in FIG. 1. As in the example of FIG. 1, the receiver 34 is disposed at the bottom edge of the display monitor 22. Extending from receiver 34 may be a signal conduit 38 which connects each of the display monitors in a daisy chain configuration.

In various examples, the signal conduit 38 may be a cable or other wired connection between the receiver 34 and the various monitors of the group of monitors 10. For example, the signal conduit 38 may be daisy-chained through dedicated IR circuitry on each monitor, an auxiliary channel, inter-integrated circuit (I²C), or any other type of circuitry configured to communicate electronic signals.

The signal conduit 38 may include cable segments 40, 42, 44, 46, 48, 50, 52, 54, 56 that extend from an output port of one monitor (or in the case of cable segment 40, the receiver 34) to the input port of another monitor. Thus, control signals from controller 38 may be received by receiver 34 and distributed to display monitors within the group of monitors 10, via the signal conduit 38 and the various cable segments.

Thus, in the illustrated example, the signal conduit 38 is configured in a daisy-chain configuration to facilitate transmittal of control signals from the receiver 34 to the signal conduit 38 for distribution of control signals to individual display monitors. From the first connected monitor 28, a transmission or conveyance path may extend to the second connected monitor 26, third connected monitor 24, etc., and to the last connected monitor 12, such that signals directed to a particular monitor follow a distribution path from the receiver to the one or more monitors at which the signal is directed.

In one example, the input ports and output ports of the receiver 34 and the display monitors 12, 14, 16, 18, 20, 22, 24, 26, 28 may be configured with modular connectors to facilitate quick and easy configuration and to accommodate different numbers of display monitors. A receiving portion may thus be configured for quick and easy connection to and disconnection from a signal conduit.

While FIG. 2 illustrates an example signal conduit 38 having a daisy-chain configuration, other examples may have a signal conduit 38 of different configurations. For example, the signal conduit 38 may be a trunk conduit with various branches leading to monitors. In this regard, the trunk conduit may be provided with a connector for communicative coupling to the receiver 34 and including any number of connection points for communicative coupling to branch lines, ultimately communicatively coupling to respective display monitors. In other examples, the receiver 34, the signal conduit 38 and/or the branch lines may be in various configurations of fixed (e.g., non-disconnectable) communicative coupling, such as in a wiring harness assembly. In various examples, the receiver 34, the signal conduit 38 and the branch lines may be configured in any number and variety of fixed and disconnectable communicative couplings to allow for adjustability and expansion of display monitor groups. Moreover, although a single receiver 34 is illustrated in connection with various examples discussed herein, in keeping with the concepts described herein, additional receivers may be incorporated in other example configurations.

Control of an individual display monitor, a subgroup of display monitors, or an entire group of display monitors (e.g., the group of monitors 10) may thus be facilitated by the controller. In various examples, the display mode, settings and input for any individual display monitor 12, 14, 16, 18, 20, 22, 24, 26, 28, any subgroup of display monitors, or the entire group of monitors 10 may be set or changed using the controller 36. For example, the controller 36 may transmit a control signal that is received by receiver 34 and distributed to display monitors 12, 14, 18, 20, via the series of daisy chain cables (40 through 56). The control signal may specify that a particular input, such as a portion of a presentation, be displayed on a subgroup of display monitors 12, 14, 18, 20, for example. Similarly, the controller 36 may transmit a signal that is received by the receiver 34 and distributed to display monitors 22, 24, 26, 28, specifying that another input, such as a streaming Internet broadcast, be displayed on these display monitors. Such a control signal may be conveyed to display monitors 22, 24, 26, 28 via the series of daisy chain cables (40 through 56). In another example, control signals regarding the picture and color settings of display monitor 26 may be transmitted by controller 36, received by receiver 34, and distributed to display monitor 26 via the series of daisy chain cables (40 through 42). In still another example, the display of an input, such as an image, streaming webcast or television broadcast, may be facilitated across all display monitors 12, 14, 16, 18, 20, 22, 24, 26, 28, in span mode or in mirror mode by the transmission of respective control signals from controller 36, receipt of the control signal by receiver 34, and distribution of the respective control signals to display monitors 12, 14, 16, 18, 20, 22, 24, 26, 28 via the series of daisy chain cables (40 through 56). The input may thus appear as a single unitary image displayed across all display monitors 12, 14, 16, 18, 20, 22, 24, 26, 28 in the group of monitors 10. In various examples, the controller 36 may transmit a control signal that is received by the receiver 34 and thus facilitates display of an identical image on each individual display monitor 12, 14, 16, 18, 20, 22, 24, 26, 28. As may be desired, settings of all display monitors 12, 14, 16, 18, 20, 22, 24, 26, 28 may be adjusted as a group, as subgroups, or individually, as described in examples above.

The selection and control of particular display monitors 12, 14, 16, 18, 20, 22, 24, 26, 28, subgroups of display monitors, or the group 10, may be facilitated through a user interface. In various examples, the user interface may be presented by the receiver 34, which may also control the monitors based on input from the controller. For example, the receiver 34 may be provided with software, hardware and/or firmware to allow control over the monitors in the group of monitors 10 of the multi-monitor display. Thus, based on input from the controller 38, the receiver 34 may control the input, brightness and other parameters of each of the monitors in the group of monitors 10.

User interface selections may be facilitated through actuation of buttons, knobs, or other control input means available on the controller 36. In various examples, the user interface may be menu driven, and may include multiple levels of menus to allow the selection of particular display monitors, subgroups or the entire group to be controlled, for example, to guide the selection of inputs and settings for the selected display monitor, subgroup or entire group. In an example, the user interface may be configured to allow control signals transmitted by the controller 36 to control or allow selection of input and/or settings for all display monitors in the group of monitors 10 simultaneously. That is, control signals transmitted by the controller 36 may cause the simultaneous and identical selection or change of inputs or settings of each display monitor in the group of monitors 10. Specific implementation methodologies may also provide for the settings of individual display monitors or subgroups to be selectable and changeable independently. Thus, inputs and settings may be selectable and adjustable for a particular display monitor, subgroup, or the entire group, while display settings of other monitors or subgroups may be selected and changed independently. A wide variety of control configurations are thus possible. Indeed, any combination of input and settings control of display monitors, subgroups and/or the group as a whole may be implemented.

Similarly, the user interface may be configurable for convenience of operability and display. For example, the user interface may be an on screen display (OSD) that is displayable on any display monitor, any subgroup, or across the entire group of monitors 10, in span or mirror mode. As discussed above, an example configuration may provide for control signals transmitted from the controller to apply to the entire group of display monitors as a whole. Control of inputs and settings for individual display monitors or subgroups may be implemented by selection of respective display monitors or subgroups. In an example, particular menus or displays of the user interface may be called up or displayed, which facilitate the entry of an input, such as a code or numerical ID (e.g., 01, 02, 03, etc.), corresponding to a particular display monitor or subgroup of monitors. Upon the entry of the corresponding input, control signals transmitted from controller 36 will facilitate implementation of the desired display input or settings for the particular display monitor or subgroup. In another example configuration, simultaneous control and adjustment of the settings of all display monitors in a group may be engaged upon entry of a specific corresponding input or numerical code, such as “00,” for example.

In still another example, a default configuration may provide for individual control of a single display monitor 12. For example, the OSD may be displayed on display monitor 12, while no display appears on the other display monitors 14, 16 18, 20, 22, 24, 26, 28, and control signals affect display monitor 12 only. The OSD may provide an option to re-configure the control configuration to allow daisy chain distribution of control signals and thus control of individual display monitors, subgroups, or the entire group of monitors 10, as discussed above, upon selection of such an option. Further, the controller 36 may be configured to include a button, switch, knob or other control input means, such as a “Menu” button, for example, the pressing or selection of which facilitates daisy-chained control, which may include the display of a menu as illustrated in the example of FIG. 3. Such a menu may appear on any or all of the display monitors in the group of monitors 10, as discussed above.

Referring now to FIG. 3, there is illustrated an example OSD menu 300. In various examples, the OSD menu 300 may be displayed on each monitor of the multi-monitor display. In various examples, the display of the OSD menu 300 on each monitor includes a display ID 302 associated with each monitor, thus allowing the user to identify a display ID associated with each monitor. In some examples, the OSD menu 300 may initially appear on all monitors or only on monitors that were previously selected for control through the OSD menu 300.

In the example of FIG. 3, an active display monitor or monitors may be the one or more monitors in the group of monitors 10 for which the signal is intended and which may be responsive to the control signal or instruction from the controller. When it is desired to change the input or settings of another monitor, subgroup, or the group as a whole, an entry may be input into new display ID field 304. When the ID of another display monitor, a subgroup of monitors or all monitors to be controlled is entered, the corresponding display monitor or monitors may be unlocked, and an OSD menu may be displayed on the newly active display monitor or monitors, for guidance and entry of respective control signals. In an example, the remaining displays may be locked, display an “OSD Locked” message, and/or ignore subsequent control signals. As discussed above, and illustrated at field 306 of the example of FIG. 3, the currently active OSD may display a message such as “Set to ‘00’ to control all displays” to indicate or provide guidance to a user about how to facilitate simultaneous control of all display monitors. In some examples, the OSD may display a message such as “Enter ‘99’ to select subgroup” to indicate or provide guidance to the user about control of a subgroup of displays in the multi-monitor display. Selection of “99” may allow further selection of a pre-defined or customized subgroup. The OSD menu 300 may also include a “Set” button 308 and an “Exit” button 310 to make active the display monitor corresponding to the newly entered display monitor ID, or to exit the menu-driven OSD control interface, respectively.

In one example, the OSD may provide an option for the user to select to exit the multi-monitor display mode. For example, if the display system includes a single monitor, the user may elect to opt out of the OSD that is configured for the multi-monitor (e.g., daisy chain) mode.

Upon selection of the display ID number, the user may use the OSD to select or adjust various parameters for a single monitor, a subgroup of monitors or all of the monitors of the multi-monitor display. For example, the user may select the input for the selected display or adjust various video or audio parameters (e.g., brightness, contrast, sharpness, color, bass level, treble level, etc.), backlight intensity, firmware/software updates or various other parameters.

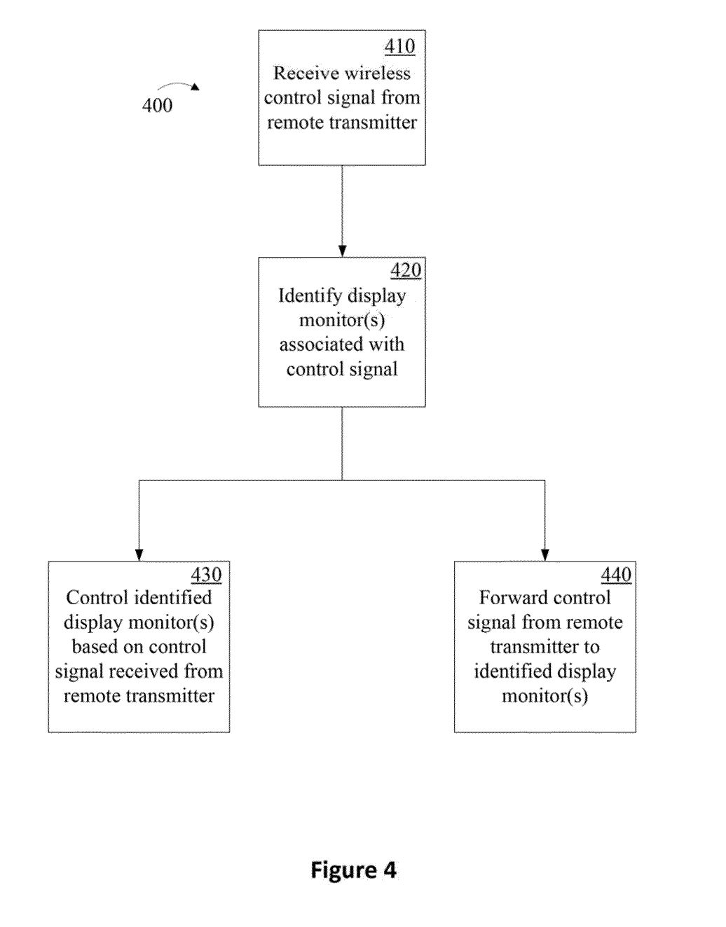

Referring now to FIG. 4, a flowchart illustrating an example process is provided. As illustrated in the example process 400 of FIG. 4, the receiver 34 may receive a wireless control signal from a remote transmitter (block 410). As noted above, the wireless control signals may be in the form of IR signals and may indicate the selection of one or more monitors in a multi-monitor display. The receiver may identify one or more display monitors that are associated with the received control signal (block 420). In this regard, as noted above, the control signal may indicate a single monitor, a subgroup of monitors or all of the monitors in the multi-monitor display. Further, the control signal may indicate a change or selection of one or more settings associated with the one or more monitors.

In one example, the receiver controls the identified one or more display monitors based on the control signal received from the remote transmitter (block 430) through the signal conduit described above. In this regard, the receiver may be provided with functionality that allows interfacing with each monitor and allowing control of the operation of each monitor of the multi-monitor display. For example, the receiver may translate the control signal received from the remote transmitter into instructions to the monitor to execute the action indicated by the control signal.

In another example, the receiver forwards the control signal received from the remote transmitter to the identified one or more display monitors (block 440) through the signal conduit described above. In this regard, the receiver may convey the control signal to the appropriate monitor(s) and rely on the monitors to execute the action indicated by the control signal.

Various examples described herein are described in the general context of method steps or processes, which may be implemented, at least in part, by a computer program product or module, embodied in a computer-readable memory, including computer-executable instructions, such as program code, and executed by computing apparatuses, including implementation in networked environments. A computer-readable memory may include removable and non-removable storage devices including, but not limited to, Read Only Memory (ROM), Random Access Memory (RAM), compact discs (CDs), digital versatile discs (DVD), etc. As such, various examples can be implemented by computer code embodied on non-transitory computer readable media. In other examples, processes may be employed to perform operations on data, wherein the instructions for process operations and the data, or elements thereof, may reside on or be transferred through one or more computing devices or systems.

Examples described herein may thus be implemented in, or via, software, hardware, application logic or a combination of software, firmware, hardware and application logic. The software, firmware, application logic and/or hardware may indeed reside on a client device, a server or a network component. If desired, part of the software, application logic and/or hardware may reside on a client device, part of the software, application logic and/or hardware may reside on a server, and part of the software, application logic and/or hardware may reside on a network component. In an example, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer apparatus or processor. A computer-readable medium may comprise a computer-readable storage medium that may be any media or means that can contain or store the instructions for use by or in connection with an instruction execution system, apparatus, or device, such as a computer. In one example, the computer-readable storage medium is a non-transitory storage medium.

The foregoing description has been presented for purposes of illustration and description. The foregoing description is not intended to be exhaustive or to limit examples to the precise form disclosed, and modifications and variations are possible in light of the above teachings or as may be acquired from the practice of various examples. The examples discussed herein were chosen and described in order to explain the principles and the nature of various examples and their practical application to enable one skilled in the art to utilize various examples and various modifications as are suited to the particular use contemplated. The features of the examples described herein may be combined in all possible combinations of methods, apparatus, modules, systems, and computer program products.

What is claimed is:

1. A system, comprising:
a multi-monitor display (10) having two or more display monitors (12-28);
a receiver (34) for receiving control signals transmitted by a controller (36); and
a signal conduit (38) for communication between the receiver (34) and the two or more display monitors (12-28),
wherein the signal conduit (38) is a wired connection from the receiver (34) to the two or more display monitors (12-28), and
wherein the signal conduit (38) transmits signals received from the controller (36) to the two or more display monitors (12-28).

2. The system of claim 1, wherein the receiver (34) is configured to receive wireless signals, the wireless signals being one of infrared (IR), Bluetooth, or radio frequency (RF).

3. The system of claim 1, wherein the signal conduit (38) includes at least one cable (40-56) which daisy chains the two or more monitors (12-28) of the multi-monitor display (10).

4. The system of claim 1, wherein the multi-monitor display (10) allows display of an input in span mode, mirror mode or multi-image mode.

5. The system of claim 1, wherein the multi-monitor display (10) is configurable into one or more subgroups, each subgroup comprising at least two of the two or more display monitors (12-28), each subgroup allowing the display of an input in span mode, mirror mode or multi-image mode.

6. The system claim 1, wherein the receiver (34) displays an interface (300) on one or more display monitors (12-28), the interface (300) allowing adjustment of settings for at least one selected display monitor.

7. The system of claim 6, wherein the at least one selected display monitor is a single one of the two or more display monitors (12-28).

8. The system of claim 6, wherein the at least one selected display monitor includes all monitors of the multi-monitor display (10).

9. The system of claim 6, wherein the at least one selected display monitor includes two or more monitors forming a subgroup of the two or more monitors of the multi-monitor display (10).

10. An apparatus comprising:
a receiver (34) for receiving wireless control signals transmitted by a controller (36); and
a signal conduit (38) for communication between the receiver (34) and two or more display monitors (12-28) of a multi-monitor display (10),
wherein the signal conduit (38) is a wired connection from the receiver (34) to the two or more display monitors (12-28), and
wherein the receiver (34) identifies one or more display monitors associated with the control signals and:
controls the identified display monitors based on the control signals received through the signal conduit (38), or
convey the control signals to the identified display monitors through the signal conduit (38).

11. The apparatus of claim 10, wherein the receiver (34) is one of an infrared (IR), a Bluetooth, or a radio frequency (RF) receiver.

12. The apparatus of claim 10, wherein the signal conduit (38) includes at least one cable (40-56) which daisy chains the two or more monitors (12-28) of the multi-monitor display (10).

13. A method, comprising:
receiving a wireless control signal transmitted by a controller (36);
identifying one or more display monitors associated with the control signal, the one or more display monitors being part of a multi-monitor display (10) having two or more display monitors (12-28); and
one of:
controlling the identified display monitors based on the control signals through a signal conduit (38), the signal conduit (38) being a wired connection to monitors of the multi-monitor display (10); or
conveying the control signals to the identified display monitors through the signal conduit (38).

14. The method of claim 13, wherein the wireless control signal is one of an infrared (IR), a Bluetooth, or a radio frequency (RF) signal.

15. The method of claim 13, wherein the signal conduit (38) includes at least one cable (40-56) which daisy chains the two or more monitors (12-28) of the multi-monitor display (10).
